(19) United States
(12) Patent Application Publication
(10) Pub. No.: US 2019/0242257 A1
(43) Pub. Date: Aug. 8, 2019

(54) PISTON AND CYLINDER APPARATUS WITH ADJUSTABLE STROKE VOLUME

(71) Applicant: SOUTHERN STIMULATION TECHNOLOGIES, LLC, Tomball, TX (US)

(72) Inventors: Ilo Ray Floyd, JR., Houston, TX (US); Robert Lee McPheron, IV, Tomball, TX (US); Chad Alan Hawkins, Tomball, TX (US)

(21) Appl. No.: 15/890,244

(22) Filed: Feb. 6, 2018

(51) Int. Cl. F01B 15/02; F16J 1/10

(52) U.S. Cl. CPC F01B 15/02; F16J 1/08; F16J 1/10

(57) ABSTRACT

A reciprocating piston and cylinder apparatus with adjustable stroke volume. The apparatus comprises an axially displaceable traveling cylinder, a stationary piston, and an optional sleeve secured to the traveling cylinder in a detachable manner. The traveling cylinder is displaced along its axis by a thrust component and acts cooperatively with the stationary piston to create a pressure change within the housing.

### FIELD

The present disclosure generally relates to a reciprocating piston and cylinder apparatus with adjustable stroke volume.

### BACKGROUND

Various mechanical devices make use of a piston and cylinder assembly for the purpose of creating pressure and/or heat. Exemplary devices include, but are not limited to: fluid pumps, internal combustion engines, heat engines, steam engines, presses, and the like.

Because the piston is the displaced component in existing art, the piston is typically secured to a driver, such as a motor. Changing the size of the piston to adapt the stroke volume, and thereby change the performance characteristics of the piston and cylinder assembly, requires the piston and cylinder assembly to be detached from the driver. Depending on the size of the machinery in question, this can be a very expensive, time consuming, and labor-intensive process.

It can often be advantageous to have the ability to change the performance characteristics of a piston and cylinder assembly, such as to use an internal combustion engine for multiple different applications, to change the parameters of a fluid pump, or change the pressure capability of a press.

It is desirable therefore, to have rapid and easy method of adjusting the properties of a cylinder and piston without detaching the apparatus from a driver. It is also desirable to have a plurality of piston sizes to choose from in order to quickly and easily adjust displacement or stroke volume, pressure, and heat generation parameters of a piston and cylinder assembly.

The present disclosure addresses the above needs.

### BRIEF DESCRIPTION OF THE DRAWINGS

The detailed description will be better understood in conjunction with the accompanying drawings as follows:

FIG. 1 depicts the presently disclosed apparatus according to one or more embodiments.

FIG. 2 depicts a typical prior art reciprocating pump.

FIG. 3 depicts a reciprocating pump with the presently disclosed apparatus according to one or more embodiments.

FIG. 4 depicts a traveling cylinder and a stationary piston according to one or more embodiments.

FIG. 5 depicts a cut view of the traveling cylinder and sleeve according to one or more embodiments.

The embodiments of the present disclosure are detailed below with reference to the listed Figures.

### DETAILED DESCRIPTION OF THE EMBODIMENTS

Before explaining the present invention in detail, it is to be understood that the invention is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present invention. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

A piston works in conjunction with a cylinder to displace a fluid within a volume when reciprocated. In industry (especially in oil and gas applications), the term piston is typically used in reference to a reciprocating member which is dynamically sealed, and the term plunger is typically used in reference to a reciprocating member which is not dynamically sealed. For the purposes of this disclosure, the term “piston” will be utilized to mean either a piston or a plunger (as defined above) interchangeably.

Components which are described as concentric shall refer to components with any shape that share the same geometric center in cross section. While typically circular cross sections are shown for clarity, the disclosure is not intended to be limited to circularly concentric shapes, and shall also refer to oval, elliptical, polygonal, or irregularly shaped cross sections.

The embodiments of the present disclosure generally relate to a reciprocating piston and cylinder apparatus with adjustable stroke volume.

The assembly comprises a traveling cylinder, a stationary piston comprising a piston shaft and a piston head, and an optional sleeve detachably secured to the traveling cylinder.

The novel arrangement of the components reverses the prior art cylinder and piston locations. This allows the cylinder to become the dynamic component, while the piston becomes the stationary component. This in turn allows for rapid adjustment of piston sizes by utilizing a sleeve without the need to disconnect the cylinder from the thrust component of a driver.

A traveling cylinder is securable to a thrust component of a driver. A typical driver can be a motor with a cam and a thrust component with a connecting mechanism to the traveling cylinder. The traveling cylinder can receive reciprocal thrust from the thrust component, thereby displacing the traveling cylinder axially.

The traveling cylinder can be secured to the thrust component by any means known to persons having ordinary skill in the art. In embodiments, the traveling cylinder is clamped to the thrust component, threaded to the thrust component using a cap, attached using a fastener, attached using a slot locking mechanism, and the like.

Optionally, a sleeve can be secured to the traveling cylinder. The thickness of the sleeve can serve to decrease the inner diameter available for the stationary piston to be concentrically positioned within. In embodiments, the sleeve can be threaded on to the traveling cylinder. In other embodiments, attachments known to persons having ordinary skill in the art can be employed, such as snap rings, locking slots, o-rings, and the like.

While it is desirable for a sleeve to be utilized in order to allow for rapid changes of configuration, in embodiments in which the sleeve is not utilized, the stationary piston can cooperate with the traveling cylinder in the manner described below.

A stationary piston can be placed concentrically within the sleeve and the traveling cylinder. In embodiments, the stationary piston is secured to a housing. The stationary piston can have a piston shaft and a piston head. The piston head can be the portion of the stationary plunger that fits snugly within the sleeve and/or traveling cylinder.

In embodiments, the piston head and piston shaft can be formed as one integral piece, or the piston head made to be detachable from the piston shaft to allow for various sizes of piston heads to be used with a given piston shaft. Similarly, this allows for various sizes of piston shafts to be used with a given piston head.

The piston shaft can be of any outer diameter equal to or less than the outer diameter of the piston head. The ratio of the diameter of the piston shaft to the diameter of the piston head can be adjusted for the desired volume of displacement of the piston and cylinder assembly, i.e. stroke volume.

The contact area between the piston head and the sleeve (or traveling cylinder if no sleeve is used) can form a seal, and the sleeve and the piston head can act cooperatively to create a change in pressure within the housing when the traveling cylinder is displaced. In embodiments, the stationary piston can comprise a fluid pathway for lubrication of the seal formed by the contact area.

It should be readily apparent to persons having ordinary skill in the art that any given cross-sectional shape of the cylinder can be utilized, as long as the piston head has a matching cross-sectional shape. In other words, the outer diameter of the piston head is substantially identical to the inner diameter of the sleeve in any given radial plane. If a sleeve is not used, the outer diameter of the piston head is substantially identical to the inner diameter of the traveling cylinder in any given radial plane.

In embodiments, the stationary piston can be detachable from the housing without detaching the traveling cylinder from the thrust component of the power end. Further, the sleeve can be detached from the traveling cylinder without detaching the traveling cylinder from the thrust component.

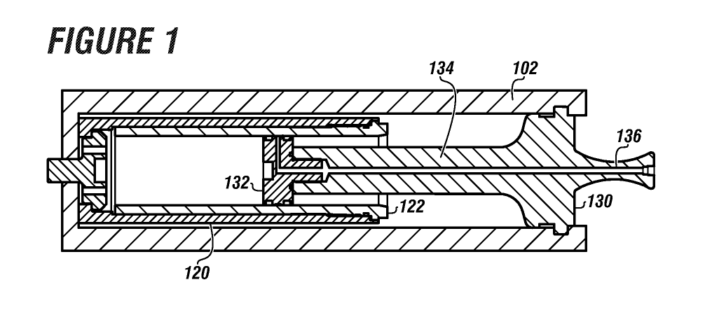

Turning now to the Figures, FIG. 1 depicts the presently disclosed apparatus according to one or more embodiments.

The apparatus can comprise a housing 102 supporting a stationary piston 130 which is positioned concentrically within a traveling cylinder 120. Sleeve 122 can be used to adjust the inner diameter of the traveling cylinder 120.

In embodiments, a piston head 132 is removable from a piston shaft 134. In other embodiments, the piston head 132 and the piston shaft 134 are formed as a single piece. Stationary piston 130 can also comprise a fluid pathway 136 for lubricating the seal formed by a contact area of the piston head 132.

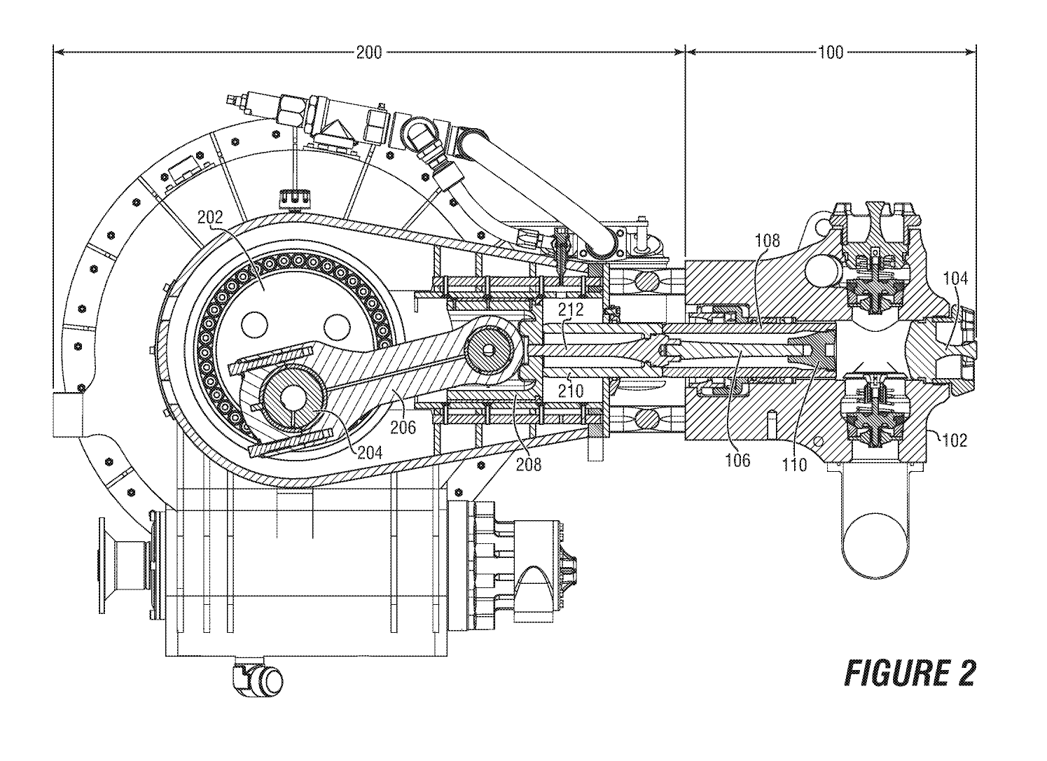

FIG. 2 depicts a typical prior art reciprocating pump.

Shown here are a power end 200 and a fluid end 100 of a reciprocating pump.

The power end 200 can have a driver 202, such as a motor and cam as shown. The driver can be connected to a crankshaft 204. One end of a connecting link 206 can be connected to the crankshaft 204 and the other end connected to a crosshead block 208. The crosshead block 208 can be connected to a pony rod 210 and a pony tie rod 212. This arrangement can cooperatively form a thrust component and provide reciprocal thrust to a plunger 108.

The fluid end 100 can comprise a housing 102 secured to the power end 200. The housing can contain the various valves for suction and discharge, as well as other common components of the reciprocating pump. As these elements are not relevant to the present disclosure, they will not be discussed and persons having ordinary skill in the art will be familiar with various arrangements utilized.

The fluid end 100 can comprise a plunger 108 having a piston tie rod 106 and a piston rod cap 110. The piston tie rod 106 can be secured to the pony tie rod 212 to receive reciprocal thrust from the power end 200. A cylinder head plug 104 can seal the housing 102.

As is apparent, the reciprocating movement of the plunger 108 pumps fluid through the fluid end 100. Further, changing the size of the plunger 108 requires the plunger 108 and its components to be disconnected for the components of the power end 200. Typically, the fluid end 100 is completely disconnected from the power end 200 in order to change out the plunger 108 or perform maintenance on the components of the plunger 108.

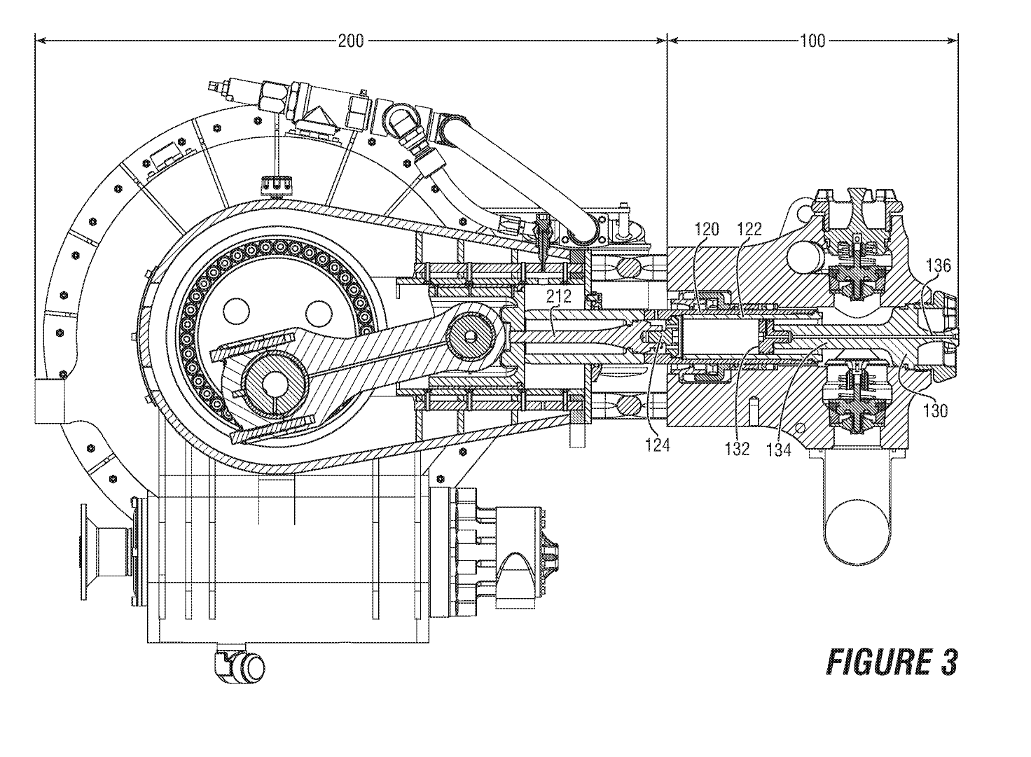

FIG. 3 depicts a reciprocating pump with the presently disclosed apparatus according to one or more embodiments.

As is readily apparent by comparison to FIG. 2, no changes in the components of the power end 200 or the fluid end 100 aside from replacement of the respective parts below are necessary to implement the assembly of the present disclosure.

Upon removal of the prior art piston assembly, the traveling cylinder 120 can be secured to the pony tie rod 212. In embodiments, the traveling cylinder 120 can be clamped or secured with a tie rod cap 124 as shown. Stationary piston 130 can be secured to the fluid end 100 and positioned concentrically within the traveling cylinder 120. Sleeve 122 can be used to adjust the inner diameter of the traveling cylinder 120. Stationary piston can have a piston head 132 and a piston shaft 134. The piston head can fit snugly within the sleeve 122, if used, or the traveling cylinder 120.

The reciprocating action of the traveling cylinder 120 can pump fluid from the fluid end 100. Stationary piston can also comprise a fluid pathway 136 for lubricating the seal formed by a contact area of the piston head 132.

In embodiments, the piston head 132 is removable from the piston shaft 134. In other embodiments, the piston head 132 and the piston shaft 134 are formed as a single piece. Stationary shaft 130 can be attached and secured to the fluid end 100 in the same manner and location as the cylinder head plug 104 in FIG. 1.

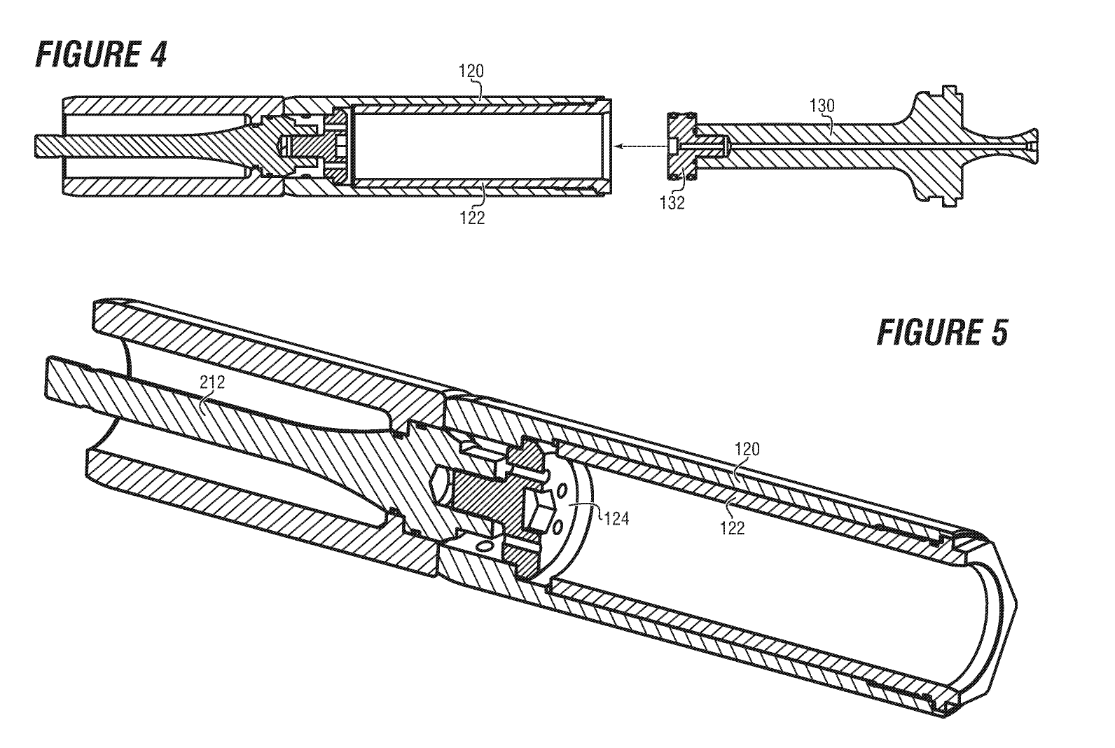

FIG. 4 depicts a traveling cylinder and a stationary piston according to one or more embodiments.

As can be seen, the stationary piston 130 can be installed concentrically into the traveling cylinder 120 and the sleeve 122 without disconnection of the traveling cylinder 120 from a driver.

FIG. 5 depicts a cut view of the traveling cylinder and sleeve according to one or more embodiments.

Shown are pony tie rod 212, tie rod cap 124, traveling cylinder 120 and sleeve 122.

The presently disclosed embodiments allow users to have a great deal of flexibility heretofore unknown in the art. An exemplary use case follows:

A contractor performing service work has a positive-displacement reciprocating pump that is configured with three plungers, commonly referred to as a triplex pump. The pump comprises five-inch plungers and is capable of producing 10,000 pounds of pressure at a flow rate of two and a half barrels per minute. The client of the contractor, however, requires a pressure of 14,000 pounds at a flow rate of two and a half barrels per minute.

In order to meet the service requirements, a triplex pump comprising three and a half inch plungers is required. Using a prior art device, an entirely different pump must be utilized, or the fluid end of the pump replaced to be able to meet the new requirements.

With an apparatus of the present disclosure, however, the contractor can simply replace the liner and the stationary piston to meet the new flow and pressure requirements. The replacement saves several hours of time and labor required and does not require the fluid end to be detached from the drive mechanism. Overall, this results in cost savings by at least a factor of four and allows for greater utilization of equipment without loss of service time.

Any art area making use of a piston and cylinder arrangement for compression or expansion can be retrofitted, or otherwise make use of the present disclosure. The present disclosure makes adjustments to stroke volume, pressure, and flow rates easy to accomplish with greatly reduced time and labor requirements.

While the present disclosure emphasizes the embodiments, it should be understood that within the scope of the appended claims, the disclosure might be embodied other than as specifically described herein.

What is claimed is:

1. A reciprocating piston and cylinder apparatus with adjustable stroke volume comprising:
a. an axially displaceable traveling cylinder secured to a thrust component for receiving reciprocating thrust;
b. optionally, a sleeve detachably secured to the traveling cylinder; and
c. a stationary piston comprising a piston head and a piston shaft fixedly positioned concentrically within the traveling cylinder and in mechanical communication with the sleeve, if used or in mechanical communication with the traveling cylinder; and
wherein the sleeve, if used and the stationary piston are configured to be removed and replaced to adjust a stroke volume of the reciprocating apparatus without detaching the traveling cylinder from the thrust component.

2. The apparatus of claim 1, further comprising a housing securing the stationary piston concentrically within the traveling cylinder, wherein the sleeve, if used and the stationary piston act cooperatively to create a change in pressure within the housing when the traveling cylinder is displaced, or the traveling cylinder and the stationary piston act cooperatively to create a change in pressure within the housing when the traveling cylinder is displaced.

3. The apparatus of claim 1, wherein the outer diameter of the piston head is substantially identical to the inner diameter of the sleeve, if used in any given radial plane or the traveling cylinder in any given radial plane.

4. The apparatus of claim 1, wherein the piston shaft is of equal or lesser diameter than the piston head.

5. The apparatus of claim 1, wherein the piston head is detachable from the piston shaft.

6. The assembly of claim 1, wherein a contact area between the piston head and the sleeve, if used comprises a seal, or the contact area between the piston head and the traveling cylinder comprises a seal.

7. The apparatus of claim 2, wherein the housing comprises an inlet and/or an outlet.

8. The assembly of claim 6, wherein the stationary piston comprises a fluid pathway for providing lubricant to the seal.
